(19) United States
(12) Patent Application Publication
(10) Pub. No.: US 2024/0099932 A1
(43) Pub. Date: Mar. 28, 2024

(54) MASSAGER

(71) Applicant: CONAIR LLC, Stamford, CT (US)

(72) Inventors: Vito CARLUCCI, Stratford, CT (US); Christiane HORMANN, Norwalk, CT (US)

(73) Assignee: CONAIR LLC, Stamford, CT (US)

(21) Appl. No.: 17/951,345

(22) Filed: Sep. 23, 2022

(51) Int. Cl. A61H 23/00; A61H 23/02

(52) U.S. Cl. CPC A61H 23/006; A61H 23/02; A61H 2201/0107; A61H 2201/0153; A61H 2201/1685; A61H 2201/1695

(57) ABSTRACT

A massager includes a housing forming a massage head portion and a handle extension portion extending from massage head portion and a plurality of removable massager attachments that include a first oscillating massager attachment and a percussion attachment that are removably connectable to the massage head portion.

### BACKGROUND 1. Field of the Disclosure

The present disclosure relates to a massager. In particular, the present disclosure is related to a massager providing oscillating massage and percussion massage.

### 2. Description of Related Art

Massagers generally provide a single type of massage by, for example, vibration. If a user desires multiple types of massage, then the user has to purchase more than one massager that undesirably increases cost and need for space for storage.

Accordingly, it has been determined by the present disclosure that there is a continuing need for a device that overcomes, alleviates, and/or mitigates one or more of the aforementioned and other deleterious effects of prior devices.

### SUMMARY

The present disclosure provides a massager that includes a housing forming a massage head portion and a handle extension portion extending from massage head portion, and a plurality of removable massager attachments that include a first oscillating massager attachment and a percussion attachment that are removably connectable to the massage head portion.

The above-described and other features and advantages of the present disclosure will be appreciated and understood by those skilled in the art from the following detailed description, drawings, and appended claims.

### DESCRIPTION OF THE DRAWINGS

FIG. 1 is a partial front perspective view of a massager according to the present disclosure connected to a first oscillating massager attachment.

FIG. 2 is a rear perspective view of the massager of FIG. 1 connected to the first oscillating massager attachment.

FIG. 3 is a partial front perspective view of the massager of FIG. 1 that is free of massager attachments.

FIG. 4 is a partial front view of the massager of FIG. 1 connected to a percussion attachment.

FIG. 5 is a front perspective view of the percussion attachment of FIG. 4.

FIG. 6 is a front perspective view of a second oscillating massager attachment.

FIG. 7 is a front perspective view of the first oscillating massager attachment of FIG. 1.

FIG. 8 is a partial front perspective view of a removable handle portion of the massager of FIG. 1 with a USB cable inserted in an interior volume of the removable handle portion.

FIG. 9 is a rear perspective view of the massager of FIG. 1 that is connected to the first oscillating massager attachment being gripped by a user to massage the user's back.

FIG. 10 is a side view of the massager of FIG. 1 that is connected to the first oscillating massager attachment and is modified to have a handle that is longer than a handle of the massager of FIG. 1.

FIG. 11 is a side view of the massager of FIG. 1 that is connected to the first oscillating massager attachment.

FIG. 12 is a side view of the massager of FIG. 1 that is modified to have a housing of a different shape, with the modified housing being connected to the first oscillating massager attachment and is modified to have a handle that is longer than the handle of FIG. 13.

FIG. 13 is a side view of the massager of FIG. 1 that is modified to have the housing of the different shape of FIG. 13 with the modified housing being connected to the first oscillating massager attachment.

FIG. 14 is a partial front perspective view of the massager of FIG. 12 that is free of massager attachments.

FIG. 15 is a partial rear perspective view of the massager of FIG. 12 that is connected to the first oscillating massager attachment.

FIG. 16 is a side view of the massager of FIG. 1 that is modified to have a housing of a different shape and the modified housing being connected to the first oscillating massager attachment.

FIG. 17 is a front perspective view of the percussion attachment of FIG. 4.

FIG. 18 is a front perspective view of a third oscillating massager attachment.

FIG. 19 is a front perspective view of the second oscillating massager attachment.

FIG. 20 is a partial front view of the massager of FIG. 16 connected to the percussion attachment of FIG. 17.

FIG. 21 is a front perspective view of the second oscillating massager attachment.

FIG. 22 is a front perspective view of the first oscillating massager attachment.

### DETAILED DESCRIPTION

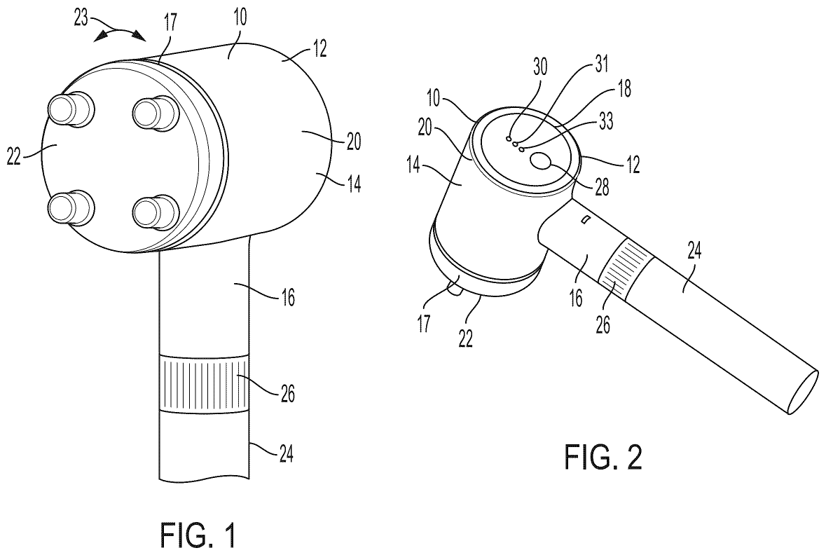

Referring to the drawings and in particular to FIG. 1, an exemplary embodiment of a massager according to the present disclosure is shown and is generally referred to by reference numeral 10. Advantageously, massager 10 provides both oscillating and percussion massage by having multiple removable massager attachments.

Still referring to FIG. 1, massager 10 has a housing 12. Housing 12 forms a massage head portion 14 and a handle extension portion 16 extending from massage head portion 14. Massage head portion 14 is a cylindrical shape that forms a first surface 17 opposite a second surface 18 (FIG. 2) having a sidewall 20 between first surface 17 and second surface 18, however, massage head portion 14 can be other shapes. Massage head portion 14 is removably connectable to a first oscillating massager attachment 22. Handle extension portion 16 is removably connectable to a removable handle portion 24. A lock ring 26 is secured between handle extension portion 16 and removable handle portion 24. Handle extension portion 16 and removable handle portion 24 are each a cylindrical shape, however, handle extension portion 16 and removable handle portion 24 can be other shapes. Handle extension portion 16 extends from sidewall 20 of massage head portion 14.

Referring to FIG. 2, massage head portion 14 has a button 28 that extends through second surface 18 of massage head portion 14. Massage head portion 14 has lights 30, 31, 33, for example, light emitting diodes (“LEDs”) that each extend through second surface 18 of massage head portion 14.

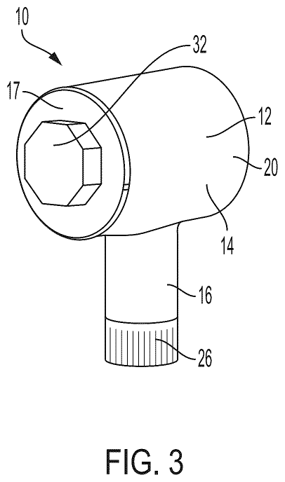

Referring to FIG. 3, massage head portion 14 has an adaptor 32 that extends outward from first surface 17 of massage head portion 14. Adaptor 32 is an octagon shape, however, adaptor 32 can be different shapes. Adaptor 32 is made of magnetic materials, however, adaptor 32 can made of non-magnetic materials. Housing 12 can also house a controller, for example, a microcontroller unit and printed circuit board that controls operation of massager 10 so that button 28 activates and deactivates a motor, and a battery, for example, a 1×18650 lithium-ion cell. The motor can rotate adaptor 32, for example, the motor can oscillate adaptor 32 by repeatedly rotating adaptor 32 clockwise 30 degrees and then counterclockwise 30 degrees.

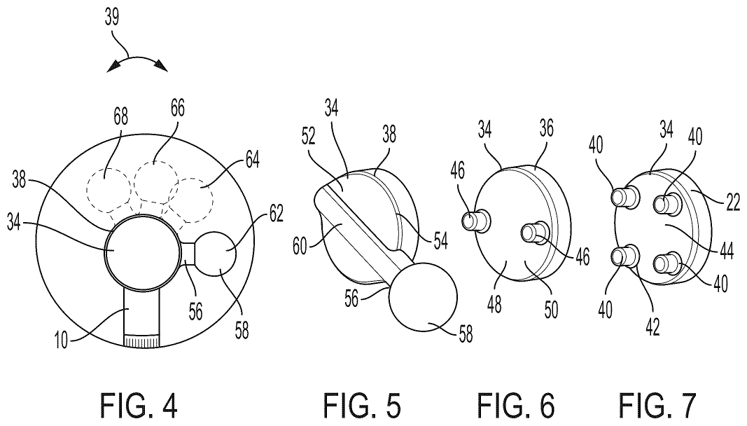

Referring to FIGS. 4-7, massager 10 has multiple removable massager attachments 34. Removable massager attachments 34 include first oscillating massager attachment 22 as shown in FIG. 7, a second oscillating massager attachment 36 as shown in FIG. 6 and a percussion attachment 38 as shown in FIG. 5.

As shown in FIG. 7, first oscillating massager attachment 22 has four protrusions 40 in a square pattern that extend from a flat circular surface 42 of a disk 44 and disk 44 has a depression that is complementary to the octagon shape of adaptor 32 on a side of disk 44 that is opposite four protrusions 40. First oscillating massager attachment 22 is made from a material that is attracted by magnets and/or disk 44 has a material that is attracted by magnets in the depression in disk 44.

As shown in FIG. 6, second oscillating massager attachment 36 has two protrusions 46 that extend on opposite sides of a flat circular surface 48 of a disk 50 and disk 50 has a depression that is complementary to the octagon shape of adaptor 32 on a side of disk 50 that is opposite two protrusions 46. Second oscillating massager attachment 36 is made from a material that is attracted by magnets and/or disk 50 has a material that is attracted by magnets in the depression in disk 50.

As shown in FIG. 5, percussion attachment 38 has a flat circular surface 52 of a disk 54 and an extension 56 extending from disk 54 to extend from a circumference of flat circular surface 52. A spherical member 58 is connected to a free end of extension 56. A half-cylinder 60 that is continuous with extension 56 protrudes from a first side of disk 54. Disk 54 has a depression that is complementary to the octagon shape of adaptor 32 on a second side of disk 54 that is opposite the firs side that has half-cylinder 60. Disk 54 is made from a material that is attracted by magnets and/or a material that is attracted by magnets in the depression in disk 54. Spherical member 58 can be a different material, for example, a flexible material such as rubber, than disk 54, extension 56 and half-cylinder 60.

Referring to FIG. 4, the octagon shape of adaptor 32 and the depression that is complementary to the octagon shape of adaptor 32 on the side of disk 54 that is opposite half-cylinder 60 allow connection of percussion attachment 38 to massage head portion 14 of massager 10 in different orientations including a first orientation 62 that is depicted as solid in FIG. 4 and a second orientation 64, a third orientation 66 and a fourth orientation 68 that are depicted as translucent in FIG. 4. First orientation 62, second orientation 64, third orientation 66 and fourth orientation 68 enable different angles of massage.

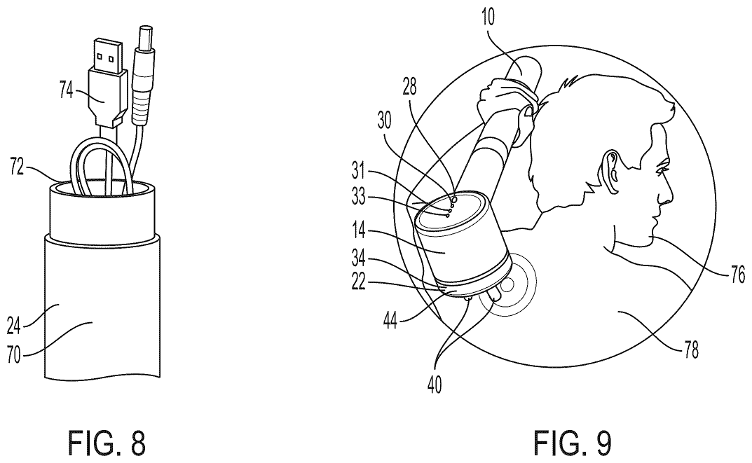

Referring to FIG. 1, removable handle portion 24 is removably connected to handle extension portion 16 by lock ring 26. For example, lock ring 26 can have a set of threads to mate with a set of threads on removable handle portion 24 to removably connect lock ring 26 and removable handle portion 24 or lock ring 26 can connect with removable handle portion 24 by friction fit to removably connect lock ring 26 and removable handle portion 24. Lock ring 26 can also have another set of threads to mate with a set of threads on handle extension portion 16 to connect lock ring 26 and handle extension portion 16 or lock ring 26 can be permanently connected to handle extension portion 16 by, for example, adhesive. Referring to FIG. 8, removable handle portion 24 has a casing 70 that forms an interior volume 72. Interior volume 72 allows for storage of a USB cable 74 inside massager 10 when removable handle portion 24 is removably connected to handle extension portion 16 by lock ring 26. Accordingly, massager 10 forms a split handle for storage so that USB cable 74 can be placed inside.

Referring to FIG. 9, during operation, a user 76 can select one of removable massager attachments 34 and place adaptor 32 in the depression in one of disks 44, 50, 54 to connect one of first oscillating massager attachment 22, second oscillating massager attachment 36 and percussion attachment 38 to massage head portion 14 of massager 10. The connection between one of first oscillating massager attachment 22, second oscillating massager attachment 36 and percussion attachment 38 to massage head portion 14 of massager 10 can be maintained by a magnetic attraction between adaptor 32 and the depression in one of disks 44, 50, 54. User 76 presses button 28 to activate massager 10. For example, by pressing button 28 the controller provides power to activate the motor to oscillate adaptor 32 by repeatedly rotating adaptor 32 clockwise 30 degrees and then counterclockwise 30 degrees to rotate one of first oscillating massager attachment 22, second oscillating massager attachment 36 and percussion attachment 38. The user can press button 28 more than one time to change a mode of massager 10 or turn massager 10 off by deactivating the motor. For example, by pressing button 28 once the controller of massager 10 activates a low mode, by pressing button 28 twice the controller of massager 10 activates a medium mode where the motor increases in speed to oscillate adaptor 32 by repeatedly rotating adaptor 32 clockwise 30 degrees and then counterclockwise 30 degrees more quickly than in the low mode, by pressing button 28 three times the controller of massager 10 activates a high mode where the motor increases in speed to oscillate adaptor 32 by repeatedly rotating adaptor 32 clockwise 30 degrees and then counterclockwise 30 degrees more quickly than in the medium mode and low mode, by pressing button 28 four times the controller of stops providing power to massager 10 to deactivate the motor to stop rotation of adaptor 32. When massager 10 is in the low mode then one of lights 30, 31, 33 is illuminated, when massager 10 is in the medium mode then two of lights 30, 31, 33 are illuminated, when massager 10 is in the high mode then three of lights 30, 31, 33 are illuminated, and when massager 10 is deactivated then zero of lights 30, 31, 33 are illuminated. User 76 can press the one of first oscillating massager attachment 22, second oscillating massager attachment 36 and percussion attachment 38 that is connected to massage head portion 14 of massager 10 against the body 78 of user 76 to apply massage. As shown in FIG. 9, user 76 can press first oscillating massager attachment 22 that is connected to massage head portion 14 of massager 10 against the body 78 of user 76 so that four protrusions 40 apply pressure to the body 78 of user 76 and four protrusions 40 are repeatedly rotated by adaptor 32 that is connected to first oscillating massager attachment 22 clockwise, for example, 30 degrees, and then counterclockwise, for example, 30 degrees, as shown by arrow 23 in FIG. 1 to apply deep tissue oscillating massage. Similarly, user 76 can press second oscillating massager attachment 36 when it is connected to massage head portion 14 of massager 10 against the body 78 of user 76 so that two protrusions 46 apply pressure to the user's body and two protrusions 46 are repeatedly rotated by adaptor 32 that is connected to first oscillating massager attachment 22 clockwise, for example, 30 degrees, and then counterclockwise, for example, 30 degrees, to apply deep tissue oscillating massage. User 76 can move percussion attachment 38 when it is connected to massage head portion 14 of massager 10 adjacent the body 78 of user 76 so that spherical member 58 can be rotated by adaptor 32 that is connected to percussion attachment 38 repeatedly to move spherical member 58 towards the body to contact the user's body and move away from the user's body as shown by arrow 39 to apply pulses of pressure to the body for percussion massage. As shown in FIG. 4 and discussed herein, the octagon shape of adaptor 32 and the depression that is complementary to the octagon shape of adaptor 32 on the side of disk 54 that is opposite half-cylinder 60 allow connection of percussion attachment 38 to massage head portion 14 of massager 10 in different orientations to enable different angle of massage.

User 76 can selectively remove the one of first oscillating massager attachment 22, second oscillating massager attachment 36 and percussion attachment 38 that is connected to massage head portion 14 of massager 10 by applying a force to the one of first oscillating massager attachment 22, second oscillating massager attachment 36 and percussion attachment 38 that is connected to massage head portion 14 that overcomes the magnetic attraction between adaptor 32 and the depression in one of disks 44, 50, 54 to disconnect the one of first oscillating massager attachment 22, second oscillating massager attachment 36 and percussion attachment 38 that is connected to massage head portion 14. Another of first oscillating massager attachment 22, second oscillating massager attachment 36 and percussion attachment 38 can then be connected to massage head portion 14 of massager 10 by placing adaptor 32 in the depression in one of disks 44, 50, 54 to connect another of first oscillating massager attachment 22, second oscillating massager attachment 36 and percussion attachment 38 to massage head portion 14 of massager 10.

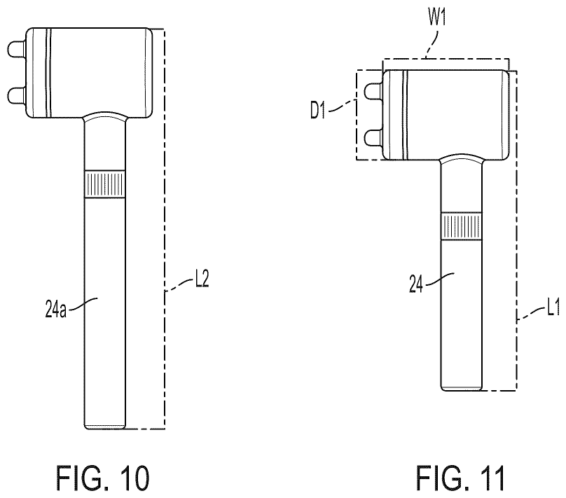

Referring to FIGS. 10 and 11, massager 10 has removable handle portion 24 that can be modified to be longer in height to have removable handle portion 24a. Massager 10 that has removable handle portion 24 can have a length L1 of 305 millimeters (“mm”). Massager 10 that has removable handle portion 24a can have a length L2 of 381 mm. Removable massager attachments 34 can have a diameter D1 of 85 mm. Massage head portion 14 and one of disks 44, 50, 54 can have a width W1 of 125 mm.

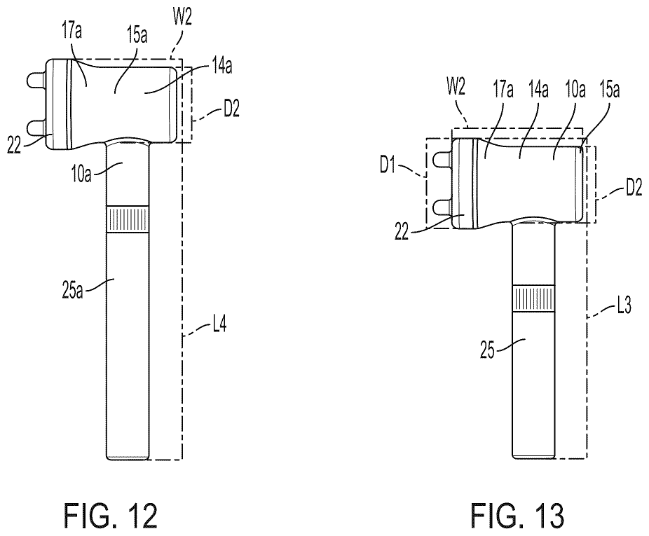

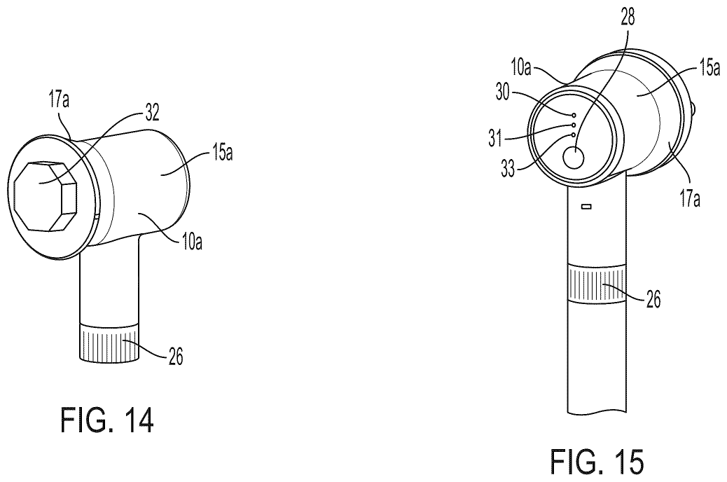

Referring to FIGS. 12-15, massager 10 can be modified to massager 10a. Massager 10a is the same as massager 10 except massager 10a has a massage head portion 14a having a different shape than massage head portion 14 and accordingly the same reference numerals will be used for the features of massager 10a that are the same as massager 10. Massage head portion 14a has a cylindrical portion 15a and a tapered portion 17a that tapers outward from cylindrical portion 15a. Massage head portion 14a and tapered portion 17a can have a width W2 of 125 mm where connected. Cylindrical portion 15a can have a diameter D2 of 70 mm. Massager 10a has removable handle portion 25 that is the same as removable handle portion 24 and can be modified to be longer in height to have removable handle portion 25a. Massager 10a that has removable handle portion 25 can have a length L3 of 305 mm. Massager 10a that has removable handle portion 25a can have a length L4 of 381 mm.

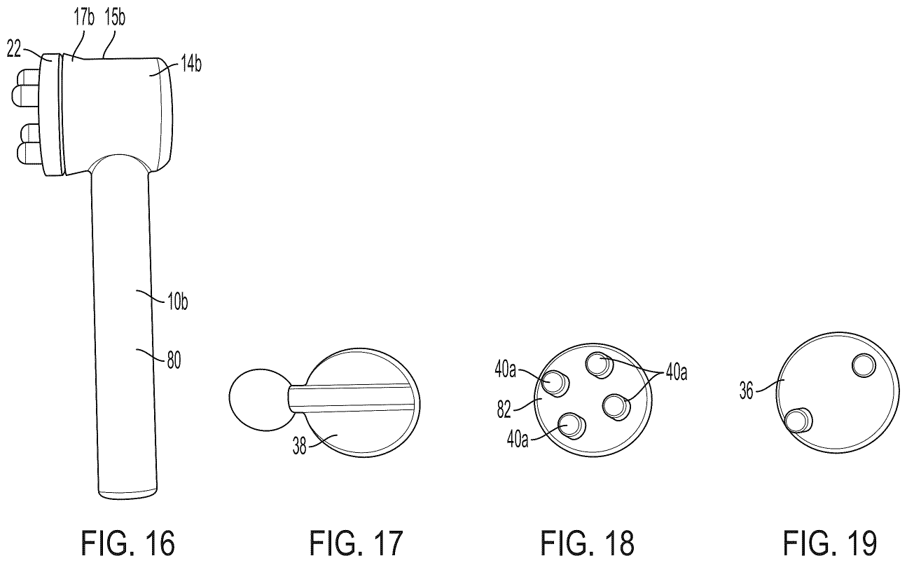

Referring to FIG. 16, massager 10 is modified to massager 10b. Massager 10b is the same as massager 10 except massager 10b has a massage head portion 14b having a different shape that massage head portion 14 and replaces lock ring 26, handle extension portion 16 and removable handle portion 24 with a handle 80. The same reference numerals will be used for the features of massager 10b that are the same as massager 10. Massage head portion 14b has a cylindrical portion 15b and a tapered portion 17b that tapers outward from cylindrical portion 15b.

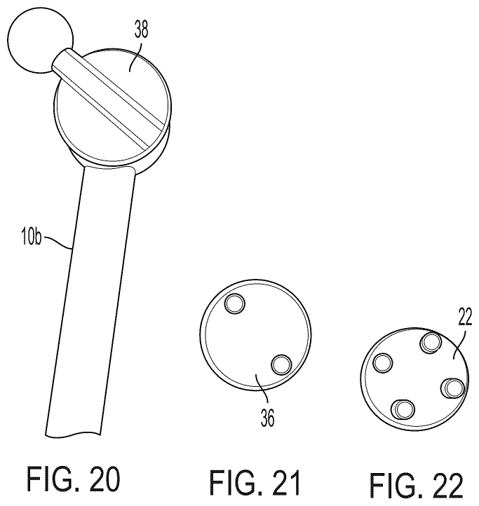

Referring to FIGS. 17-22, massager 10b is connectable to first oscillating massager attachment 22, second oscillating massager attachment 36 and percussion attachment 38 as well as a third oscillating massager attachment 82 as shown in FIG. 18. Third oscillating massager attachment 82 is the same as first oscillating massager attachment 22 except third oscillating massager attachment 82 replaces four protrusions 40 with four protrusions 40a that are closer together.

Advantageously, massager 10, 10a, 10b provide multiple types of massage, namely, both oscillating and percussion massage by having multiple removable massager attachments 34. A further advantage includes that the user does not have to purchase more than one massager that undesirably increases cost and need for space for storage.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure should not be limited to the particular embodiment(s) disclosed as the best mode contemplated, but that the disclosure will include all embodiments falling within the scope of the appended claims.

1. A massager comprising:
a housing forming a massage head portion and a handle extension portion extending from a massage head portion; and
a plurality of removable massager attachments that include a first oscillating massager attachment and a percussion attachment that are removably connectable to the massage head portion.

2. The massager of claim 1, wherein the massage head portion is a cylindrical shape that forms a first surface opposite a second surface having a sidewall between the first surface and the second surface.

3. The massager of claim 1, wherein the handle extension portion extends from the sidewall of the massage head portion.

4. The massager of claim 1, wherein the handle extension portion is removably connectable to a removable handle portion.

5. The massager of claim 1, further comprising a lock ring that removably connects the handle extension portion to the removable handle portion.

6. The massager of claim 2, wherein the massage head portion has an adaptor that extends outward from the first surface of the massage head portion.

7. The massager of claim 6, wherein the adaptor is an octagon shape.

8. The massager of claim 6, wherein the adaptor is made of magnetic materials.

9. The massager of claim 6, wherein the adaptor is rotatable.

10. (canceled)

11. The massager of claim 6, wherein the first oscillating massager attachment has four protrusions in a square pattern that extend from a flat circular surface of a disk and the disk has a depression that is complementary to the shape of the adaptor on a side of the disk that is opposite the four protrusions.

12. The massager of claim 6, further comprising a second oscillating massager attachment that has two protrusions that extend on opposite sides of a flat circular surface of a disk and the disk has a depression that is complementary to the shape of the adaptor on a side of the disk that is opposite the two protrusions.

13. The massager of claim 6, wherein the percussion attachment has a flat circular surface of a disk and an extension extending from the disk to extend from a circumference of the flat circular surface.

14. The massager of claim 13, further comprising a spherical member that is connected to a free end of the extension.

15. The massager of claim 13, further comprising a half-cylinder that is continuous with the extension that protrudes from a first side of disk.

16. The massager of claim 15, wherein the disk has a depression that is complementary to the shape of the adaptor on a side of the disk that is opposite the half-cylinder.

17. The massager of claim 7, wherein the octagon shape of the adaptor and the depression that is complementary to the octagon shape of the adaptor on the disk allow connection of the percussion attachment to the massage head portion in different orientations including to enable different angles of massage.

18. The massager of claim 5, wherein the removable handle portion has a casing that forms an interior volume that allows for storage of a USB cable.

19. The massager of claim 6, wherein the first oscillating massager attachment is repeatedly rotated by the adaptor clockwise and then counterclockwise to apply oscillating massage when the first oscillating massager attachment is connected to the massage head portion.

20. The massager of claim 14, wherein the spherical member is rotated by the adaptor to repeatedly to move the spherical member clockwise and then move the spherical member counterclockwise to apply pulses of pressure to a body of a user for percussion massage when the percussion attachment is connected to the massage head portion.

21. The massager of claim 9, wherein the adaptor oscillates by repeatedly rotating clockwise and then counterclockwise.
